(19) United States
(12) Patent Application Publication
(10) Pub. No.: US 2008/0057371 A1
(43) Pub. Date: Mar. 6, 2008

(54) Separator for Fuel Cell and Method for Producing Same

(75) Inventors: Mineo Washima, Tsuchiura (JP); Masahiro Seido, Tsuchiura (JP); Takaaki Sasaoka, Tsuchiura (JP); Katsumi Nomura, Tsuchiura (JP)

Correspondence Address: FOLEY AND LARDNER LLP;SUITE 500, 3000 K STREET NW, WASHINGTON, DC, 20007, US

(73) Assignee: HITACHI CABLE, LTD.

(21) Appl. No.: 11/791,317

(22) PCT Filed: May 24, 2006
(86) PCT No.: PCT/JP06/10399

§ 371 Date: Jul. 19, 2007

(30) Foreign Application Priority Data
May 25, 2005 (JP) 2005-152730

(51) Int. Cl. H01M 8/10; B05D 5/12

(52) U.S. Cl. 429/33; 427/124; 427/125; 429/34

(57) ABSTRACT

Disclosed is a separator for fuel cells which is decreased in the amount of an expensive noble metal used as a raw material while being maintained to be conductive to the MEA. This separator has durability and corrosion resistance to very corrosive substances such as fluorine ions or hydrofluoric acid. Also disclosed is a method for producing such a separator for fuel cells. Specifically disclosed is a metal separator (15, 17) which is used in a polymer electrolyte fuel cell using a fluorine-containing polymer electrolyte membrane. This metal separator (15, 17) comprises a stainless steel base (20) processed to have a plurality of fuel gas channels (14). A pure Ti layer (21) is formed on the surface of the base (20); a Pd layer (23) is formed on a surface of the pure Ti layer (21) on the side of the fluorine-containing polymer electrolyte membrane; and a composite metal layer (22) is made of the pure Ti layer (21) and the Pd layer (23) by alloying at least a part of the Pd layer (23) joined with the surface of the pure Ti layer (21) through a heat treatment.

### TECHNICAL FIELD

This invention relates to a fuel cell separator used in polymer electrolyte fuel cells and a production method thereof, and particularly, to a fuel cell separator and a production method thereof, capable of reducing the amount of noble metal used while maintaining its conductivity with a membrane electrode assembly (an MEA), and obtaining corrosion resistance and durability to strong corrosive substances such as fluorine ions, hydrofluoric acid, and the like.

### BACKGROUND ART

Fuel cells are not only high-efficient because they are capable of directly transforming a chemical change into electrical energy, but are also global environment-friendly because of no nitrogen, sulfur, etc. -containing fuels combusted and therefore few amounts of air pollutants (NOₓ, SOₓ, etc.) to be exhausted. As types of these fuel cells, there are polymer electrolyte fuel cells (PEFCs), phosphoric acid fuel cells (PAFCs), molten carbonate fuel cells (MCFCs), solid oxide fuel cells (SOFCs), etc. Among others, polymer electrolyte fuel cells are expected to be widely used as power for automobiles, home, etc., and as mobile device power supplies or uninterruptible power supplies, in the future.

FIG. 8 is a cross-sectional view illustrating the structure of a unit cell of a polymer electrolyte fuel cell with separators formed of graphite (herein, graphite separators), as prior art. This polymer electrolyte fuel cell (herein, fuel cell) 100 comprises an MEA (membrane electrode assembly) 104 constructed by a polymer electrolyte membrane 101, a fuel electrode 102, and an oxidant electrode 103, a graphite separator 106 with fuel gas channels 105 formed to face one side (the fuel electrode) of the MEA 104, a graphite separator 108 with oxidant gas channels 107 formed to face the other side (the oxidant electrode) of the MEA 104, and gaskets 109A and 109B sandwiched between the graphite separators 106 and 108, to seal the perimeter of the MEA 104.

The fuel electrode 102 is formed to have an anode catalytic layer and an outer gas diffusive (dispersive) layer thereof on one side of the polymer electrolyte membrane 101. The oxidant electrode 103 is formed to have a cathode catalytic layer and an outer gas diffusive (dispersive) layer thereof on the other side of the polymer electrolyte membrane 101. Also, the graphite separators 106 and 108 serve to electrically connect the fuel electrode 102 and the oxidant electrode 103, and to prevent mixing of the fuel and oxidant.

Such fuel cell 100 generates electricity by an electrochemical reaction utilizing hydrogen in the fuel gas and oxygen in the oxidant gas, in approximately 80° C. environment.

The hydrogen in the fuel gas flowing through the fuel gas channels 105 comes into contact with the catalytic layer of the fuel electrode 102, to thereby cause the following reaction:
2H₂→4H⁺+4e⁻

The hydrogen ion H⁺ moves to the opposite electrode in the polymer electrolyte membrane 101, arrives at the catalytic layer of the oxidant electrode 103, and reacts with the oxygen in the oxidant gas of the oxidant gas channels 107 to form water.
4H⁺+4e⁻+O₂→2H₂O

The above electrode reaction causes electromotive force, and this electromotive force is taken to outside via the graphite separators 106 and 108.

In the fuel cell, to obtain a desired output voltage, the specified number of the fuel cells 100 as shown in FIG. 8 are used to be connected in serial. For this reason, the number of the separators may be a few tens to more than one hundred.

Conventionally, used as separator materials for fuel cells are mainly graphite-based materials, from the point of view of corrosion resistance and conductivity. There is however the problem that the graphite separators produced by cutting are high in production cost, and as the number of the separators used is increased as mentioned above, the cost of the fuel cell system is very high. Also, in the graphite separators produced by resin molding, there is difficulty in making the graphite separators thin from the point of view of mechanical strength, and reducing the size of the fuel cell system.

Accordingly, use of corrosion-resistant metals, such as stainless steel (SUS), has been suggested as the separator materials. It is however well known that, when stainless steel is used without surface treatment as the separator material of the polymer electrolyte fuel cell, the constituent elements of the stainless steel are dissolved out, leading to damage of the separator and degradation of fuel cell characteristics.

To prevent this, a separator is known that uses stainless steel as its base, to form thereon a 0.01-0.06 μm-thick Au (gold) plating layer, to thereby make contact resistance small (see JP-A-10-228914, for example). Similarly, a metal separator is known that uses stainless steel as its base, to form thereon an acid-resistant film of Ta (tantalum), Zr (zirconium), Nb (niobium), Ti (titanium), etc., and apply thereon a not more than 0.1 μm (0.03 μm in its embodiment)-thick conductive film plating of Au, Pt (platinum), Pd (palladium), etc., to thereby improve corrosion resistance and conductivity (see JP-A-2001-93538, for example).

However, the above thin noble metallic film is porous, and does not entirely cover the surface of the stainless steel. For this reason, although the conductivity is not unsatisfactory, the corrosion resistance is unsatisfactory because the constituent elements of the stainless steel are dissolved out by long-term use, leading to degradation of fuel cell characteristics. To avoid the problem of the corrosion resistance, on the other hand, when the noble metallic film is made thick, the problem of the corrosion resistance is solved, but the cost is high, which is therefore not practical.

To obviate this problem, there is a metal separator as shown in JP-A-2001-297777, in which a 3-50 nm film of at least one or more noble metals selected from the group of Au, Ru (ruthenium), Rh (rhodium), Pd, Os (osmium), Ir (iridium) and Pt, or oxide portion of the noble metal(s), is applied to the surface of a metal sheet of SUS, Al (aluminum), Ti, or the like, to thereby provide high conductivity and corrosion resistance.

Also, JP-A-2004-158437, for example, discloses a metal separator, which has a less than 0.0005-0.01 μm-thick noble metal film of Au, Pt, Ru, Pd, or the like, applied to contact portion with a gas diffusive layer as a conductive contact layer, in a Ti cladding material with a Ti-based corrosion-resistant metal cladded on the surface of a corrosion-resistant metal material such as stainless or the like, to provide excellent conductivity and corrosion resistance.

Cited reference 1: JP-A-10-228914 ([0006], 0010], FIG. 4)

Cited reference 2: JP-A-2001-93538 ([0015]-[0018])

Cited reference 3: JP-A-2001-297777 ([0012]-[0017])

Cited reference 4: JP-A-2004-158437 ([0037]-[0041], [0047], FIGS. 1-4)

### DISCLOSURE OF INVENTION

Problems to be Solved by the Invention

Also, in the conventional metal separators for fuel cells, the corrosion resistance to sulfuric acid on the order of pH 2-3 at approximately 80° C., for example, is ensured to some extent. In fuel cells using a fluorine-containing polymer electrolyte membrane, however, strong corrosive substances such as fluorine ions or hydrofluoric acids are produced based on degradation and decomposition of the electrolyte membrane, under severe operation conditions, especially where power supply ON/OFF is repeated, etc. (power supply ON/OFF is inevitably repeated many times for long-term use), which leads to a new significant problem hitherto not considered of corroding the metallic materials of the metal separators, piping materials, etc. And the new problem (of producing strong corrosive substances such as fluorine ions or hydrofluoric acids) leads to a concern with deterioration in long-term reliability, in the metal separators of JP-A-2001-297777 and JP-A-2004-158437 as well.

Accordingly, it is an object of the present invention to provide a fuel cell separator and a production method thereof, capable of reducing the amount of noble metal used that is high in raw material cost while maintaining its conductivity with the MEA, and obtaining corrosion resistance and durability to strong corrosive substances such as fluorine ions, hydrofluoric acid, and the like.

Means for Solving the Problems

In accordance with one aspect of the invention, a fuel cell separator used in a polymer electrolyte fuel cell using a fluorine-containing polymer electrolyte membrane comprises:

a metal sheet comprising a first metal comprising Ti or a Ti alloy at least in its surface layer on the side of the fluorine-containing polymer electrolyte membrane; and

a second metal layer formed on the fluorine-containing polymer electrolyte membrane side surface of the first metal,

wherein the second metal layer is alloyed at least at its junction with the surface of the first metal.

In accordance with another aspect of the invention, a method for producing a fuel cell separator comprises the steps of:

forming a specified thickness of a metal sheet comprising a first metal comprising Ti or a Ti alloy at least in its surface layer on a fluorine-containing polymer electrolyte membrane side;

forming a second metal layer on the fluorine-containing polymer electrolyte membrane side surface of the first metal; and

alloying at least a junction between the first metal and the second metal layer.

Advantages of the Invention

According to the present invention, it is possible to provide a fuel cell separator and a production method thereof, capable of reducing the amount of noble metal used while maintaining its conductivity with the MEA, and obtaining corrosion resistance and durability to strong corrosive substances such as fluorine ions, hydrofluoric acid, and the like.

### BRIEF DESCRIPTION OF DRAWINGS

FIG. 1 is a cross-sectional view illustrating an example of a unit cell of a polymer electrolyte fuel cell in an embodiment according to the present invention.

FIG. 2 is a cross-sectional view illustrating detail of a metal separator of FIG. 1.

FIG. 3 is a diagram showing one example of results of surface analysis, by a scanning electron microscopy-energy dispersive X-ray spectrometer (SEM-EDX), of a Ti cladding material with a pure Ti layer coated with a Pb layer according to the present invention.

FIG. 4 is a photograph showing the result of a fluorine environment resistance test of a metal separator material in an embodiment according to the present invention.

FIG. 5 is a diagram showing results of evaluation of contact resistance characteristics, based on differences in the composition of the metal separator material.

FIG. 6 is a diagram showing results of evaluation of contact resistance characteristics, based on differences in the heat treatment condition in the fabricating process of the metal separator material.

FIG. 7 is a photograph showing the appearance of a metal separator fabricated.

FIG. 8 is a cross-sectional view illustrating the structure of a unit cell of a polymer electrolyte fuel cell using a graphite separator.

### NUMERALS

1 fuel cell

10 fluorine-containing polymer electrolyte membrane

11 fuel electrode

12 oxidant electrode

13 MEA

14 fuel gas channel

15, 17 metal separator

16 oxidant gas channel

18, 19 gasket

20 base

21 pure Ti layer

22 composite metal layer

23 Pd layer

100 fuel cell (polymer electrolyte fuel cell)

101 polymer electrolyte membrane

102 fuel electrode

103 oxidant electrode

104 MEA

105 fuel gas channel

106, 108 graphite separator

107 oxidant gas channel

109A, 109B gasket

### BEST MODE FOR CARRYING OUT THE INVENTION

Polymer Electrolyte Fuel Cell Structure

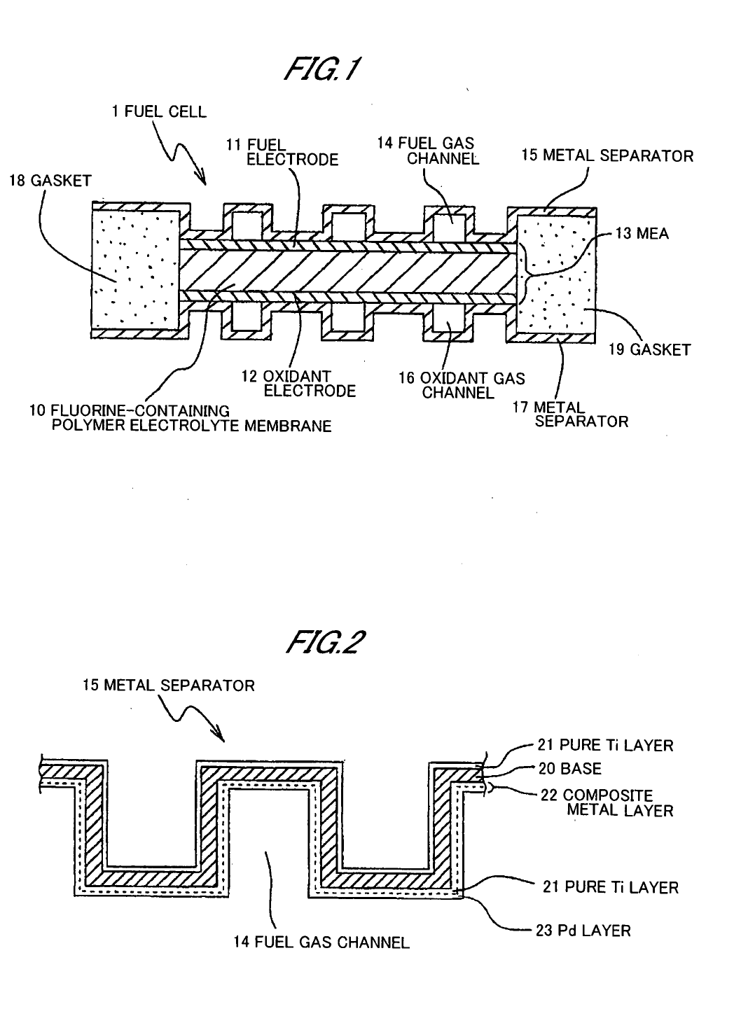

FIG. 1 is a cross-sectional view illustrating an example of a unit cell of a polymer electrolyte fuel cell in an embodiment according to the present invention. MEA 13 is formed of a fluorine-containing polymer electrolyte membrane 10, a fuel electrode 11 provided on one side of the fluorine-containing polymer electrolyte membrane 10, and an oxidant electrode 12 provided on the other side of the fluorine-containing polymer electrolyte membrane 10. The fuel electrode 11 and the oxidant electrode 12 are each formed to have a catalytic layer and an outer gas diffusive (dispersive) layer thereof. Fuel cell 1 comprises the MEA 13, a metal separator 15 serving as a separator for fuel cells having a plurality of fuel gas channels 14 formed in a cross-sectional shape of recessed grooves on one side (the fuel electrode 11) of the MEA 13, a metal separator 17 serving as a separator for fuel cells having a plurality of oxidant gas channel 16 formed in a cross-sectional shape of recessed grooves on the other side (the oxidant electrode 12) of the MEA 13, and gaskets 18 and 19 interposed between the metal separators 15 and 17, and serving as a sealing member to seal the perimeter of the MEA 13.

This fuel cell 1 is assembled by sealing a pair of the metal separators 15 and 17 with the gaskets 18 and 19, applying an appropriate pressure to and fixing the pair of the metal separators 15 and 17.

The fluorine-containing polymer electrolyte membrane 10 may use perfluorosulfonic-acid-based or perfluorocarbon-acid-based ion exchange materials, such as Nafion (registered trademark, manufactured by E.I. du Pont de Nemours and Company), or Flemion (registered trademark, manufactured by Asahi Glass Co., Ltd.), for example.

The operation principle of the fuel cell according to this embodiment is similar to that of the fuel cell shown in FIG. 8, and is therefore omitted herein.

Also, from the point of view of reduction in internal loss of the fuel cell, the contact resistance between the MEA and the metal separators is desirably as low as on the order of at least not more than 150 mΩ·cm² required, more desirably not more than 100 mΩ·cm², still more desirably not more than 70 mΩ·cm².

Metal Separator Structure

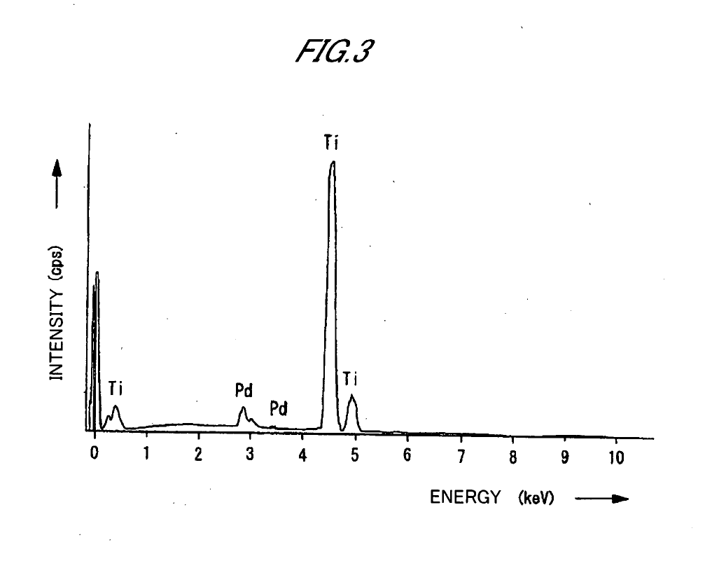

FIG. 2 illustrates a detailed structure of the metal separator 15. Although only the metal separator 15 is shown herein, the metal separator 17 also has the same structure. This metal separator 15 comprises a corrosion-resistant metal, such as a stainless steel base 20, a pure Ti layer 21 as a first metal layer formed on both sides of the base 20, and a composite metal layer 22 containing a Pd layer 23 as a second metal layer formed on the pure Ti layer 21 of at least one side of the base 20. This composite metal layer 22 has a Ti—Pd alloy at a junction between the pure Ti layer 21 and the Pd layer 23. The “corrosion-resistant metal” refers to a metal whose oxide forms a passive film in the atmosphere, such as stainless steel, Al alloys, Mg alloys, Ti, etc., and the “pure Ti” refers to JIS types 1-3.

Here, the thickness of the Pd layer 23 is preferably 2-10 nm on average before being alloyed with the pure Ti layer 21. More preferably, it is 3-9 nm. Still more preferably, it is 4-8 nm. The reason for the upper limit being 10 nm is because the amount used of noble metal high in raw material cost is restricted. Also, the reason for the lower limit being 2 nm is because the thickness of the Pd layer 23 being below 2 nm makes high the probability of the Pd layer 23 being covered with the Ti oxide by heat treatment described later, and causes difficulty in ensuring conductivity (causes an increase in contact resistance with the MEA. The thickness of the Ti oxide film is generally said to be on the order of approximately 2 nm.

Also, the average composition ratio of surface layer portion (e.g., its thickness on the order of 1 μm) of the Pd layer 23 formed in the composite metal layer 22 is preferably such that the atomic ratio of Pd to Ti is not less than 0.005 to not more than 0.03, the atomic ratio of O to Ti is not less than 0.1 to not more than 1, and the atomic ratio of Pd to O is not less than 0.02 to not more than 0.08, more preferably 0.01≦Pd/Ti≦0.03, 0.2≦O/Ti≦0.9, and 0.02≦Pd/O≦0.06, still more preferably 0.015≦Pd/Ti≦0.03, 0.2≦O/Ti≦0.85, and 0.02≦Pd/O≦0.05. Further, the above-mentioned average composition ratio of the surface layer portion (e.g., its thickness on the order of 1 μm) may be quantitatively analyzed by surface analysis using an energy dispersive X-ray spectrometer (e.g., acceleration voltage: 15 kV, area: approx. 60×approx. 80 μm²), for example.

Metal Separator Fabrication Method

<First Step>

Next, a method for fabricating the metal separator 15 will be explained by way of examples.

First, a 20 μm-thick pure Ti layer 21 is cladded on both sides of a 0.16 mm-thick stainless steel (e.g., SUS316L) sheet as a first metal layer.

<Second Step>

Next, by sputtering, EB evaporation (electron beam evaporation) or the like, an average 5 nm-thick Pd layer 23, for example, is formed on the MEA 13-side pure Ti layer 21 as a second metal layer. In this case, by inverse sputtering, ion bombardment or the like, it is preferable that cleaning of the surface of the pure Ti layer 21 (for example, elimination of the remaining oil content and natural oxide film on the surface) is performed immediately before the Pd layer 23 formation.

<Third Step>

Subsequently, heat treatment is performed under specified conditions, to cause diffusion in the interface between the pure Ti layer 21 and the Pd layer 23 and thereby create a Ti—Pd alloy therebetween, to form a composite metal layer 22, while at the same time, combining a pure Ti layer portion uncovered with the Pd layer and atmospheric oxygen, to form a Ti oxide film.

In this condition, the Ti layer 21 is formed on the base 20 side, the Pd layer 23 is formed on the fluorine-containing polymer electrolyte membrane 10 (MEA 13) side, and the Ti—Pd alloy is formed between the pure Ti layer 21 and the Pd layer 23. The Pd layer 23 may be formed on both sides on the pure Ti layer 21, but it is desirable, from the point of view of cost, etc., that the Pd layer 23 be formed on only the fluorine-containing polymer electrolyte membrane 10 (MEA 13) side. The average thickness of the Pd layer 23 maybe controlled by measuring beforehand the average film formation rate of Pd (for example, measuring thickness of film (not island) formation and dividing it by time of the film formation to thereby obtain the average film formation rate), and adjusting the film formation time, since (average thickness)=(average film formation rate)×(film formation time).

The above heat treatment is performed at temperatures of higher than 250° C. and not higher than 400° C., in the atmosphere or oxic ambient. The temperature of the heat treatment is preferably in the range of not lower than 280° C. and not higher than 390° C., more preferably around 350° C. (on the order of 300-370° C.). The mechanism for the above heat treatment temperatures being optimal cannot thoroughly be elucidated, but it is thought that the reason for the heat treatment temperatures of higher than 250° C. being appropriate is because heat energy necessary for Ti-platinum group alloying (effective diffusion) is given, and that the reason for the heat treatment temperatures of not higher than 400° C. being appropriate is because excessive Ti oxide film formation leading to an increase in contact resistance with the MEA is restrained. It is preferable that the heat treatment time is adjusted so that the average composition ratio of surface layer portion (e.g., its thickness on the order of 1 μm) of the Pd layer 23 formed in the composite metal layer 22 falls within the above-mentioned range.

Also, the alloying method is performed preferably by heat treatment using a typical electrical furnace, form the point of view of convenience, cost and the like, but other methods may also be applied thereto.

The above steps (the 1^{st}-3^{rd} steps) are followed by metal separator formation. The metal separator is manufactured by molding (cutting, pressing, etc.) the metal separator material. Of the above steps, the 2^{nd} and 3^{rd} steps may be performed either before or after the metal separator molding.

As described above, the alloying after the pure Ti layer 21 being nanolevel-coated with the Pd layer 23 results in a large merit of reducing the amount of expensive Pd used, etc. In this embodiment, the nanolevel film formation technique by sputtering, etc. is utilized for high-precision formation of the junction between Ti and the platinum group element such as Pd, etc., and furthermore, the diffusive heat treatment is applied for allowing the platinum group element atoms to be present close to the Ti atoms not chemically bonded to oxygen in the outermost surface of the separator, so that it is thought that electrons are supplied for being electrochemically noble.

The Ti—Pd alloy is not limited to being formed at the junction between the pure Ti layer 21 and the Pd layer 23, but may be formed such that the entire composite metal layer 22 is a Ti—Pd alloy according to diffusion conditions. Also, the alloying condition is not particularly limited, but there may be differences in Pd concentration according to portions so that it is desirable that the Pd concentration is not low in portions being in contact with the gas diffusive (dispersive) layer of the fuel electrode 11 and the oxidant electrode 12.

Also, the first metal layer may, besides pure Ti, be a Ti alloy (e.g., JIS type 11). The Ti alloy is used that has corrosion resistance on the same order or more than that of pure Ti. Also, the second metal layer may, instead of Pd, use any, or 2 or more of Pt (platinum), Ru (ruthenium), Rh (rhodium), and Ir (iridium), or these combined with oxygen. Among others, using 1 or 2 or more of Pd, Pt, and Ru; or these combined with oxygen is preferable. In the cases of Pt, Ru, Rh, etc., the average composition ratio of surface layer portion (e.g., its thickness on the order of 1 μm) of the second metal layer formed in the composite metal layer with Ti, is also preferably such that the atomic ratio of the second metal to Ti is not less than 0.005 and not more than 0.03, the atomic ratio of O to Ti is not less than 0.1 and not more than 1, and the atomic ratio of the second metal to O is not less than 0.02 and not more than 0.08, more preferably 0.01≦second metal/Ti≦0.03, 0.2≦O/Ti≦0.9, and 0.02≦second metal/O≦0.06, still more preferably 0.015≦second metal/Ti≦0.03, 0.2≦O/Ti≦0.85, and 0.02≦second metal/O≦0.05.

### Advantages of the Embodiment

The advantages of this embodiment are as follows:
(1) Sufficient corrosion resistance can be obtained because of no variation in contact resistance seen even in hydrofluoric acid ambient environment.
(2) The function as power collection can also be substantially enhanced because of good electrical contact with the gas diffusive (dispersive) layer of the MEA.

This invention is not limited to the above embodiment, but its various modifications may be possible without altering the scope of the invention.

### Embodiments

Fabricating Metal Sheets 1-3 for Separators

First, a 1 mm-thick stainless steel (SUS316L) sheet is prepared as a base, and a first metal (Ti: JIS type 1) layer is cladded, rolled and joined to both sides of the base so that the thickness ratio is 10% each, and the sheet (metal sheet 1) is fabricated to have the entire thickness of 0.2 mm.

Also, a 1 mm-thick aluminum alloy (Al—Mg alloy: JIS 5083) sheet is prepared as a base, and a junction metal (Al: JIS 1050) layer and a first metal (Ti: JIS type 1) layer are cladded, rolled and joined so that the thickness ratio of the constituent materials, the first metal layer, junction metal layer and base, is 20%, 5% and 75% respectively. In this case, the junction metal layer is formed to be interposed between the base and the first metal layer. This is followed by junction heat treatment (e.g., 500° C.×10 min) and subsequent finish rolling, and the sheet (metal sheet 2) is fabricated to have the entire thickness of 0.3 mm.

Also, a 0.2 mm-entire-thickness Ti (Ti: JIS type 1) sheet (metal sheet 3) is prepared.

Forming the Second Metal Layer

The second metal layer is formed by using an RF sputtering apparatus (SH-350 manufactured by ULVAC, Inc.). The atmosphere during the formation is Ar, and the pressure is 1 Pa, and the RF output is adjusted appropriately according to metal kinds. The thickness of the second metal layer is controlled by measuring beforehand the average film formation rate for each metal kind and then adjusting the film formation time.

Analysis Results

FIG. 3 is a diagram showing one example of results of analysis of the surface of the composite metal layer 22 according to the present invention, by a scanning electron microscopy-energy dispersive X-ray spectrometer (SEM-EDX; acceleration voltage: 15 kV, area: approx. 60×approx. 80 μm²) The SEM is S-4300 manufactured by Hitachi, Ltd., and the EDX is EMAX-300 manufactured by Horiba, Ltd. The samples shown in the figure, are those immediately after the 5 nm (average film thickness) Pd layer is formed on the above-mentioned metal sheet 1. From this analysis, it is found that the nano thin film of the Pd layer 23 is very thin, or is clustered (dispersed in island shapes) in the surface, and that the signals of the underlying pure Ti layer 21 are therefore distinctly observed.

Hydrofluoric Acid Environment Resistance Test for the Metal Separator

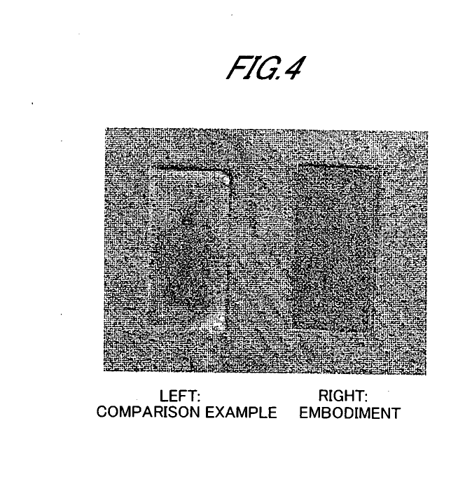

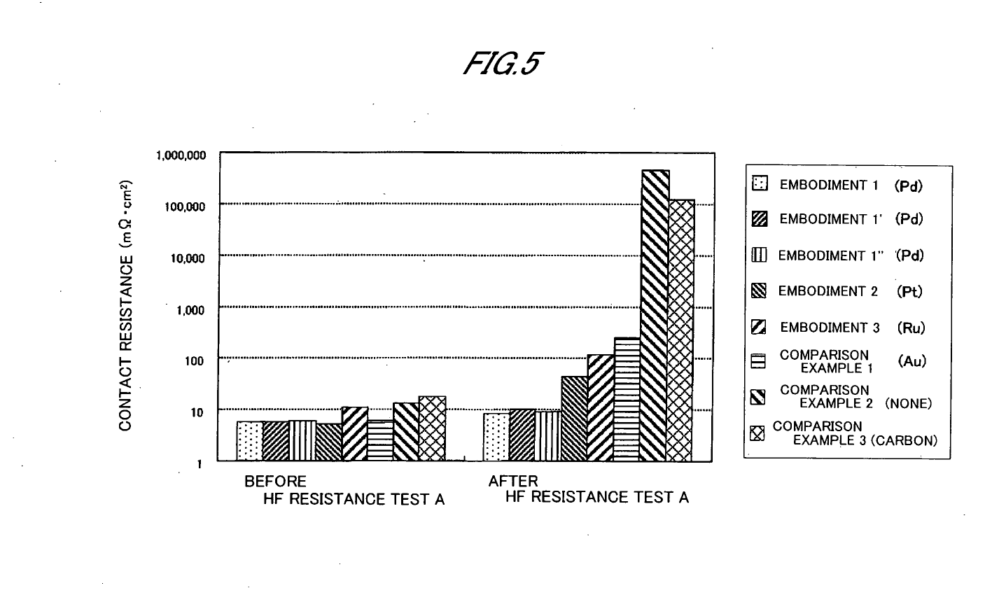

FIG. 4 shows the result of a hydrofluoric acid environment resistance test A of the metal separator in this embodiment. This hydrofluoric acid environment resistance test A performs 24 hour holding in 80° C., 0.5 wt % hydrofluoric acid solution vapor atmosphere. This is followed by observation of the surface after testing.

The samples used in the test are prepared as follows. As an embodiment, a 5 nm (average film thickness) Pd layer 23 is formed on the above-mentioned metal sheet 1, followed by atmospheric heat treatment of 250° C.×1 hr, where 250° C. is the setting temperature of the apparatus, and the actual temperature around the samples is approximately 260° C. The heat treatment is performed using a commercial oven (DV600 manufactured by Yamato Scientific Co., Ltd.). As a comparison example, on the other hand, no Pd layer 23 is formed on the above-mentioned metal sheet 1.

In the figure, the left shows the comparison example where the outermost layer is the pure Ti layer 21 only, and the right shows the embodiment where a composite metal layer 22 is formed by applying the Pd layer 23 and applying the specified heat treatment. It is found that the metal separator with no Pd layer causes distinct surface alteration, whereas the metal separator with the composite metal layer 22 formed by applying the Pd layer 23 and applying the specified heat treatment exhibits good corrosion resistance and durability with little alteration recognized.

Metal Separator Structure and Contact Resistance Characteristics

Next, the structure (material) of the metal separator is varied variously, to measure the contact resistance with the gas diffusive (dispersive) layer of the MEA before and after the hydrofluoric acid environment resistance test A, to evaluate the characteristics thereof. The contact resistance is measured as follows. Used as the gas diffusive (dispersive) layer of the MEA is a carbon paper (TGP-H-060 manufactured by Toray Industries, Inc.). A metal separator material (2×2 cm²) prepared is sandwiched between Au-plated Cu blocks via the carbon paper, to apply a weight (20 kg/cm²) by a hydraulic press machine, to measure the contact resistance between the metal separator material and the carbon paper by a 4-terminal measurement method (AX-125A manufactured by Adex corporation).

The samples used in this evaluation test are prepared as follows. 5 nm-average-thickness Pd (embodiment 1), Pt (embodiment 2), Ru (embodiment 3), and Au (comparison example 1) thin films each are sputtered and formed on the surface of a Ti cladding material (above-mentioned metal sheet 1) with pure Ti layer 21 applied to both sides of base 20 (SUS316L), followed by atmospheric heat treatment of 250° C.×1 hr, where 250° C. is the setting temperature of the apparatus, and the actual temperature around the samples is approximately 260° C. Also, there are prepared a sample (embodiment 1′) with a 5 nm-average-thickness Pd thin film sputtered and formed on the surface of above-mentioned metal sheet 2 as a second metal layer, followed by the same heat treatment as in embodiment 1, and a sample (embodiment 1″) likewise having a 5 nm-average-thickness Pd thin film sputtered and formed on the surface of above-mentioned metal sheet 3, followed by the same heat treatment as in embodiment 1. The second metal layer is formed by using an RF sputtering apparatus (SH-350 manufactured by ULVAC, Inc.; atmosphere: Ar, pressure: 1 Pa). The heat treatment is performed using a commercial oven (DV600 manufactured by Yamato Scientific Co., Ltd.).

In addition, there are prepared comparison example 2 (Ti-SUS-Ti only, metal sheet 1), and comparison example 3 (metal sheet 1 with approximately 20 μm-thick conductive carbon applied thereon by a method disclosed in JP-A-2000-138067, for example)

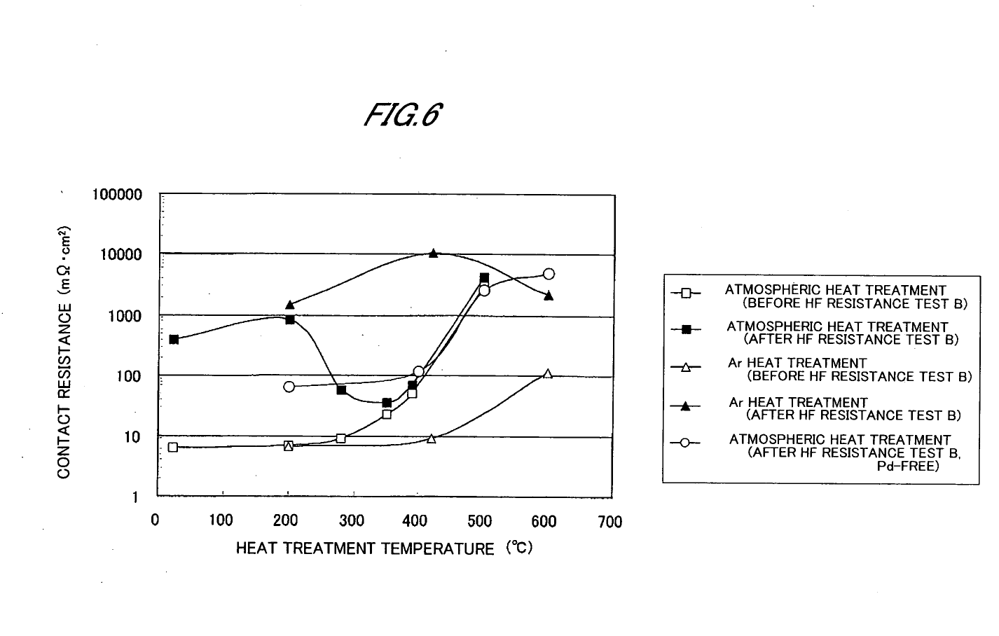

FIG. 5 shows results of evaluation of contact resistance characteristics, based on differences in the composition of the metal separator material. In the figure, the left shows the characteristics before hydrofluoric acid environment resistance test A, and the right shows the characteristics after hydrofluoric acid environment resistance test A.

As apparent from FIG. 5, the Ti cladding materials with no Pd, etc. applied thereto, comparison examples 2 and 3, cause a 4 or more-figure increase in contact resistance seen, whereas the samples (embodiments 1, 1′ and 1″) with the Pd layer 23 formed on the Ti surface and followed by the specified heat treatment have few variations (few increases) in contact resistance seen before and after the hydrofluoric acid environment resistance test A. Also, the Pt (embodiment 2) and Ru (embodiment 3), which belong to the same platinum group as does Pd, cause an increase in contact resistance on the order of 10 times, but have sufficient corrosion resistance by the surface treatment for fuel cells. In the case of Au coating (comparison example 1), on the other hand, because Au itself is noble metal, it exhibits the anti-corrosive effect in comparison to the comparison examples 2 and 3, but causes a very large (approximately 40 times) increase in contact resistance before and after the hydrofluoric acid environment resistance test A in comparison to the embodiments according to the present invention. In other words, it is found that the embodiments according to the present invention are clearly good.

Heat Treatment Conditions and Contact Resistance Characteristics

Next, the heat treatment conditions in the metal separator manufacturing process are varied variously, to measure the contact resistance before and after hydrofluoric acid environment resistance test B, to examine the relationship between the heat treatment conditions and contact resistance characteristics.

The samples used in this evaluation test are prepared as follows. A 10 nm-average-thickness Pd thin film is sputtered and formed on the surface of a Ti cladding material (above-mentioned metal sheet 1) with pure Ti layer 21 applied to both sides of base 20 (SUS316L), followed by heat treatment in the atmosphere or argon (Ar), for 1 hr, at temperatures shown in Table 1. Also, for comparison, there are prepared samples using above-mentioned metal sheet 1 with no Pd thin film formed thereon, to which is applied heat treatment in the atmosphere, for 1 hr, at temperatures shown in Table 2. The heat treatment in the atmosphere is performed using a typical electrical furnace (KDF-S80 manufactured by DENKEN Co., Ltd.), and the heat treatment in the Ar is performed using a typical electrical furnace (VF-616Y manufactured by ULVAC-RIKO, Inc.) and passing a high-purity argon gas into the furnace. These 2 furnaces are at substantially the same setting temperature of the apparatus, and substantially the same actual temperature around the samples.

The hydrofluoric acid environment resistance test B is performed by protecting each sample with a heat resistant tape excluding a 1 cm×1 cm exposed portion, making a test piece, and holding it in a weak acid fluorine ion solution on the order of pH 3 (fluorine concentration: 200 ppm), at 80° C., and for 24 hrs. The contact resistance with a carbon paper is measured before and after the hydrofluoric acid environment resistance test B, by the same above-mentioned method. Also shown in Table 1 are contact resistance measurement results of the samples with the Pd thin film formed on the pure Ti layer surface, and ratios of contact resistances after to before the hydrofluoric acid environment resistance test B (contact resistance after test B/contact resistance before test B). Also shown in Table 2 are contact resistance measurement results before the hydrofluoric acid environment resistance test B, and observation results after the hydrofluoric acid environment resistance test B, of the samples with no Pd thin film formed on the pure Ti layer surface.

TABLE 1
Heat treatment conditions and contact resistance measurement results for samples with their
Pd thin film formed on pure Ti layer surface

| | Atmosphere | | | | | | | Argon (Ar) | |
|---|---|---|---|---|---|---|---|---|---|
| | Heat treatment temperature (° C.) | | | | | | | | |
| Ambient | 23 (*1) | 200 | 280 | 350 | 390 | 500 | 200 | 420 | 600 |
| Before test B (*2) | 6.4 | 6.8 | 9.0 | 23 | 51 | 3.0 × 10³ | 6.6 | 9.0 | 1.2 × 10² |
| After test B (*3) | 4.0 × 10² | 8.4 × 10² | 58 | 36 | 69 | 4.2 × 10³ | 1.5 × 10³ | 10.7 × 10³ | 2.2 × 10³ |
| Ratio of after to | 62 | 123 | 6.4 | 1.6 | 1.4 | 1.4 | 221 | 1199 | 19 |
| before test B | | | | | | | | | |

| | | | | | |
|---|---|---|---|---|---|
| Comparison | Embdmt. 4 | Embdmt. 5 | Embdmt. 6 | Comparison | Comparison |
| Example 4 | | | | Example 5 | Example 6 |

(*1) No heat treatment
(*2) Contact resistance before hydrofluoric acid environment resistance test B (mΩ · cm²)
(*3) Contact resistance after hydrofluoric acid environment resistance test B (mΩ · cm²)

TABLE 2
Heat treatment conditions and contact resistance
measurement results for samples with no
Pd thin film formed on their pure Ti layer surface

| | |
|---|---|
| Ambient | Atmosphere |

| | | | | |
|---|---|---|---|---|
| Heat treatment | 200 | 400 | 500 | 600 |
| temperature (° C.) | | | | |
| Before test B | 65 | 120 | 2.6 × 10³ | 5.0 × 10³ |
| (*4) | | | | |

| | | |
|---|---|---|
| After test B | Melted | Not tested |
| | Comparison | Comparison |
| | Example 7 | Example 8 |

(*4) Contact resistance before hydrofluoric acid environment resistance test B (mΩ · cm²)

FIG. 6 graphically shows results of measurement of contact resistances shown in Tables 1 and 2, and shows results of evaluation of contact resistance characteristics, based on differences in the heat treatment condition in the fabricating process of the metal separator material. In the figure, □, Δ and ◯ show characteristics before the hydrofluoric acid environment resistance test B, and ▪ and ▴ show characteristics after the hydrofluoric acid environment resistance test B.

As apparent from Tables 1 and 2 and FIG. 6, the samples (comparison example 4), with the Pd thin film formed on the pure Ti layer surface and followed by no heat treatment, and by 200° C. atmospheric heat treatment, cause a substantial (2-figure) increase in contact resistance seen. On the other hand, the samples (embodiments 4-6), which are subject to around 350° C. (280-390° C. ) atmospheric heat treatment, cause few increases in contact resistance. Also, the sample (comparison example 5), which is subject to 500° C. atmospheric heat treatment, has the small ratio of after to before the hydrofluoric acid environment resistance test B (i.e., the small contact resistance increase), but has the large contact resistance when subject to the heat treatment. In other words, the sample (comparison example 5), which is subject to 500° C. atmospheric heat treatment, is high in practical contact resistance, and is therefore thought to be unsuitable for practical use.

As shown in comparison example 6, on the other hand, the samples, which are subject to heat treatment in the argon (Ar), have the distinct increase (large ratio of after to before the test B) in contact resistance seen, and are very high (higher than 1×10³ mΩ·cm²) in contact resistance after the hydrofluoric acid environment resistance test B, and are therefore thought to be unsuitable for the metal separators for fuel cells of the present invention. In other words, the present invention strongly indicates the significance of the atmospheric or oxic ambient heat treatment.

Also, the samples (comparison example 7), with no Pd thin film formed on the pure Ti layer surface and followed by 200-400° C. atmospheric heat treatment, are high in contact resistance when subject to the heat treatment, in comparison with embodiments 4-6, and cause surface melting due to the hydrofluoric acid environment resistance test B observed. This shows insufficient corrosion resistance to the hydrofluoric acid environment. In other words, this strongly indicates the significance of composite metal layer 22 formation according to the present invention.

Further, the samples (comparison example 8), which are subject to 500-600° C. atmospheric heat treatment, are very high (higher than 1×10³ mΩ·cm²) in contact resistance when subject to the heat treatment, and are therefore thought to be unsuitable for practical use.

Results of Analyzing the Average Composition Ratio

With respect to the samples which are subject to the above atmospheric heat treatments, the surface of the composite metal layer 22 according to the present invention is analyzed by a scanning electron microscopy-energy dispersive X-ray spectrometer (SEM-EDX; acceleration voltage: 15 kV, area: approx. 60×approx. 80 μm²). The results thereof are shown in Table 3. The SEM is S-4300 manufactured by Hitachi, Ltd., and the EDX is EMAX-300 manufactured by Horiba, Ltd.

TABLE 3
Average composition ratio of surface layer portion of composite metal
layer 22 in samples subject to atmospheric heat treatment

| | | Comparison | | | | | Comparison |
|---|---|---|---|---|---|---|---|
| | | Example 4 | | Embodiment 4 | Embodiment 5 | Embodiment 6 | Example 5 |
| | | Heat treatment temperature (° C.) | | | | | |
| | | 23 (*5) | 200 | 280 | 350 | 390 | 500 |
| Before | Pd/Ti | 0.026 | 0.021 | 0.020 | 0.021 | 0.019 | 0.022 |
| test B | O/Ti | 0.10 | 0.17 | 0.26 | 0.49 | 0.65 | 1.2 |
| | Pd/O | 0.26 | 0.13 | 0.076 | 0.042 | 0.029 | 0.017 |
| After | Pd/Ti | 0 | 0 | 0.023 | 0.022 | 0.022 | 0.026 |
| test B | O/Ti | 1.1 | 2.9 | 0.93 | 0.83 | 0.89 | 1.2 |
| | Pd/O | 0 | 0 | 0.025 | 0.026 | 0.025 | 0.021 |

(*5) No heat treatment

Comparing the above various experiments (heat treatment in the atmosphere and argon, and presence/absence of the Pd thin film of the pure Ti layer surface), the following model is thought as a mechanism of the present invention. In the present invention, since the Pd (platinum group element) thin film layer is very thin (or is dispersed in island shapes), the region alloyed by heat treatment is thought not to cover the entire underlying Ti layer surface. Here, when oxygen is present in the heat treatment atmosphere, the surface region unalloyed with Pd is thought to be oxidized to form a Ti oxide film. And this Ti oxide film is thought to contribute largely to enhancement in hydrofluoric acid environment resistance. On the other hand, the Ti—Pd alloy (Ti-platinum group alloy) is thought to ensure conductive paths (contribute to a decrease in contact resistance), and have the effect of regenerating the above Ti oxide film corroded (dissolved) by hydrofluoric acid (see the results of FIG. 5).

As seen from the results of Table 1 (FIG. 6) and Table 3, on the other hand, in the case of comparison example 4 at the low heat treatment temperature, the contact resistance ratio of after to before the hydrofluoric acid environment resistance test B is large, and no Pd is detected from the surface portion of the composite metal layer 22 after the test B. This reason is thought to be because the alloying in the composite metal layer is insufficient, and the Pd thin film layer disappearance is caused by the hydrofluoric acid environment test. In other words, this strongly indicates the significance of alloying of the first metal (e.g., pure Ti) and second metal (platinum group element, e.g., Pd) layers at the junction thereof. Combined with the results of FIG. 5, higher than 250° C. heat treatment is thought to be necessary for effective alloying.

Also, in the event of too high atmospheric heat treatment temperatures (e.g., comparison example 5), the ratio of after to before the hydrofluoric acid environment resistance test B (i.e., the contact resistance increase) is small, but has the large contact resistance when subject to the heat treatment. This is thought to be caused by multiple effects of a robust (or thick) Ti oxide film, etc. formed by atmospheric heat treatment, and stabilized by being alloyed with Pd.

Continuous Electrical Conduction Test and Start/Stop Test

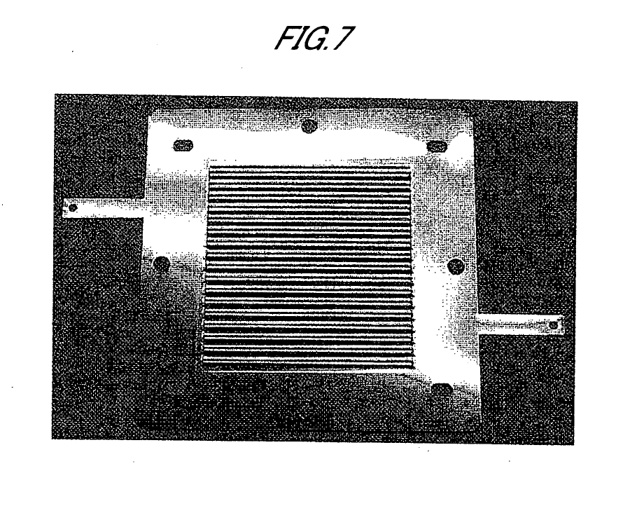

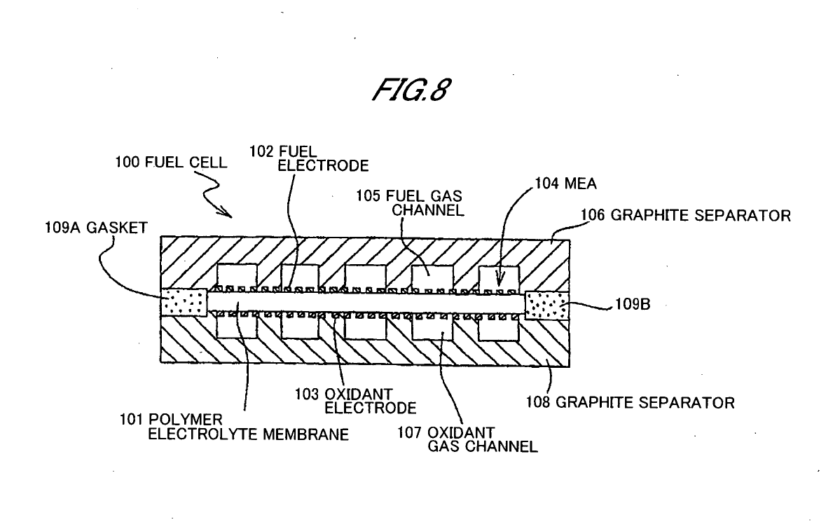

A metal separator member is prepared in the same procedure as in embodiment 5 (metal sheet 1+Pd coating (10 nm)+atmospheric heat treatment (35° C.×1 hr)), followed by press to fabricate a metal separator. Shown in FIG. 7 is a photograph of the appearance of a metal separator fabricated.

The channels (the horizontal grooves, i.e., the horizontal recessed portions in FIG. 7) for a fuel gas (or an oxidant gas) are 48 mm in length, 3 mm in pitch (of the alternate recessed and protruding portions formed vertically in FIG. 7), and 0.5 mm in depth (i.e., the difference in height between the recessed and protruding portions in FIG. 7). Used as a fluorine-containing polymer electrolyte membrane is Nafion 112 (registered trademark, manufactured by E.I. du Pont de Nemours and Company), and its electrodes for power generation are 50×50 mm² sized. Used as an electrode catalyst is a 0.6 mg/cm² Pt-supported catalyst (TEC10V50E, manufactured by Tanaka Kikinzoku Kogyo Co., Ltd.), and used as a gas diffusive (dispersive) layer is a carbon paper (TGP-H-060 manufactured by Toray Industries, Inc.). The metal separator is sandwiched by gaskets serving both fuel gas (or oxidant gas) channel formation and as sealing members, resulting in a prototype fuel cell structured, as shown in FIGS. 1 and 2.

Also, for comparison, there is prototyped a fuel cell with a high-purity dense graphite separator substituted for the above metal separator.

The conditions for power generation are that the load current density is 0.5 A/cm², and the gases are fed so that the availabilities of the fuel gas and oxygen (oxidant gas) in the air are 70% and 40% respectively. Continuous electrical conduction testing (1500 hrs) verifies that the 2 fuel cells, one using the metal separator according to the present invention, and the other using the conventional graphite separator, can both restrain the decrease of electromotive force per operating hours within not more than 5 mV/kh, to provide the same power generation characteristic.

Next, start/stop testing is performed for 1000 hrs (10000 cycles), wherein the ON/OFF of an external load is switched every 3 minutes (6 minutes/cycle). In this case, the constant fuel gas and oxidant gas are fed in the same conditions as in the above electrical conduction test. Also, when the external load is ON, the load current density is 0.5 A/cm². From the results of the test, the 2 fuel cells exhibit the same power generation characteristic. This shows that the present invention can provide the metal separator having durability and corrosion resistance equivalent to those of the graphite material.

From the above, it is found that the durable fluorine ion concentration is enhanced and the hydrofluoric acid resistance is further enhanced by the Pd coating and the subsequent heat treatment in the specified conditions.

1. A fuel cell separator used in a polymer electrolyte fuel cell using a fluorine-containing polymer electrolyte membrane, comprising:
a metal sheet comprising a first metal comprising Ti or a Ti alloy at least in its surface layer on the side of the fluorine-containing polymer electrolyte membrane; and
a second metal layer formed on the fluorine-containing polymer electrolyte membrane side surface of the first metal,
wherein the second metal layer is alloyed at least at its junction with the surface of the first metal.

2. The fuel cell separator according to claim 1, wherein:
the metal sheet further comprises a base comprising a corrosion-resistant metal, and a layer of the first metal formed on the outer side of the base.

3. The fuel cell separator according to claim 1, wherein:
the second metal layer comprises one or two or more metals of Pd, Pt, Ru, Rh, and Ir, or these metals combined with oxygen.

4. The fuel cell separator according to claim 3, wherein:
the average composition ratio of a surface layer portion of the fuel cell separator is such that, in surface analysis thereof using an energy dispersive X-ray spectrometer,
the atomic ratio of the second metal to Ti is not less than 0.005 and not more than 0.03,
the atomic ratio of the oxygen to Ti is not less than 0.1 and not more than 1, and the atomic ratio of the second metal to the oxygen is not less than 0.02 and not more than 0.08.

5. The fuel cell separator according to claim 2, wherein:
the base comprises stainless steel or an aluminum alloy.

6. A method for producing a fuel cell separator, comprising the steps of:
forming a specified thickness of a metal sheet comprising a first metal comprising Ti or a Ti alloy at least in its surface layer on a fluorine-containing polymer electrolyte membrane side;
forming a second metal layer on the fluorine-containing polymer electrolyte membrane side surface of the first metal; and
alloying at least a junction between the first metal and the second metal layer.

7. The method for producing a fuel cell separator according to claim 6, wherein:
the step of forming a specified thickness of a metal sheet further comprises providing a specified thickness of the first metal on the outer side of a base comprising a corrosion-resistant metal.

8. The method for producing a fuel cell separator according to claim 6, wherein:
the second metal layer comprises one or two or more metals of Pd, Pt, Ru, Rh, and Ir, or these metals combined with oxygen.

9. The method for producing a fuel cell separator according to claim 8, wherein:
the step of forming a second metal layer comprises forming the second metal layer by sputtering or EB evaporation.

10. The method for producing a fuel cell separator according to claim 8, wherein:
the step of forming a second metal layer comprises forming the second metal layer so that the average thickness of the second metal layer is 2-10 nm.

11. The method for producing a fuel cell separator according to claim 8, wherein:
the step of alloying at least a junction between the first metal and the second metal layer is performed by heat treatment at temperatures within the range of 250-400° C. in the atmosphere or oxic ambient.

12. The fuel cell separator according to claim 2, wherein:
the second metal layer comprises one or two or more metals of Pd, Pt, Ru, Rh, and Ir, or these metals combined with oxygen.

13. The fuel cell separator according to claim 3, wherein:
the base comprises stainless steel or an aluminum alloy.

14. The fuel cell separator according to claim 4, wherein:
the base comprises stainless steel or an aluminum alloy.

15. The method for producing a fuel cell separator according to claim 7, wherein:
the second metal layer comprises one or two or more metals of Pd, Pt, Ru, Rh, and Ir, or these metals combined with oxygen.
